(19) United States
(12) Patent Application Publication
(10) Pub. No.: US 2019/0044883 A1
(43) Pub. Date: Feb. 7, 2019

(54) NETWORK COMMUNICATION PRIORITIZATION BASED on AWARENESS of CRITICAL PATH of a JOB

(71) Applicant: Intel Corporation, Santa Clara, CA (US)

(72) Inventors: Janusz Piotr Jurski, Beaverton, OR (US); Jonathan Eastep, Portland, OR (US); Keith D. Underwood, Powell, TN (US); Madhusudhan Rangarajan, Portland, OR (US)

(73) Assignee: Intel Corporation, Santa Clara, CA (US)

(21) Appl. No.: 15/868,110

(22) Filed: Jan. 11, 2018

(51) Int. Cl. H04L 12/911; H04L 12/927; H04L 29/08

(52) U.S. Cl. CPC H04L 47/826; H04L 67/1095; H04L 47/805

(57) ABSTRACT

In multi-processor systems, some large jobs are performed by dividing the job into multiple tasks, having each task executed in parallel by separate nodes, and combining or synchronizing the results into a final answer. When communications between nodes represent a significant portion of total performance, techniques may be used to monitor and balance communications between the nodes so that the tasks will be completed at approximately the same time, thereby accelerating the completion of the job and avoiding wasting time and power by having some processors sit idle while waiting for other processors to catch up. Multiple synchronization points may be set up between the start and finish of task execution, to that mid-course corrections may be made.

### TECHNICAL FIELD OF THE INVENTION

Various embodiments of the invention relate to improving overall execution time of a job in a parallel multi-processing system by adjusting communication resources that affect time-to-completion of different paths in the parallel system. An additional benefit is to reduce power consumption by reducing the amount of time various elements may have to sit in an idle state waiting for other elements to complete.

### BACKGROUND

Multi-node systems may split the job they need to accomplish into multiple tasks, with the tasks being executed in parallel by the available processing nodes. However, if the various tasks are not completed at the same time, some of the nodes must wait for the others to complete before all the results can be combined and/or synchronized. This waiting time may result in inefficiency because some of the nodes are idle some of the time. To achieve maximum efficiency, identical nodes may work on identical tasks, which theoretically should result in simultaneous completion. However, this doesn't always happen. In particular, High Performance Computing (HPC) systems may have different execution speeds of their nodes due to manufacturing variations and other causes.

But an even greater source of variation may come from communications. In large scale HPC computing systems, the various processors may be connected through network links or shared communication channels/buses. Communication over these channels may be utilized to exchange data (e.g., retrieve some input data, store the results, communicate with other nodes, etc.). This may represent as much as 50% of overall job completion time. When the network is in the cloud datacenter, this variation may be even greater due to the extensive communications involved—there are RPC calls across the datacenter for many different functions—and due to the fact that the final cloud user who runs the workload may have no direct control over where and how the processing nodes are placed, often sharing the network with many other workloads. Although techniques have been developed to speed up progress in overall processing time, these do not affect the communication time and therefore may not improve the overall job completion time.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a diagram of a multi-node processing system, according to an embodiment of the invention.

FIG. 2 shows a processor device, according to an embodiment of the invention.

FIG. 3 shows a timing chart of a system of parallel nodes, according to an embodiment of the invention.

FIG. 4 shows a flow diagram of a method of execution along a critical path, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. The instructions may be read and executed by one or more processors to enable performance of the operations described herein. The medium may be internal or external to the device containing the processor(s), and may be internal or external to the device performing the operations. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term ‘node’, as used in this document, refers to a computing entity that executes code and performs communication, to achieve particular results while working in parallel with other nodes to complete a job. Depending on the scale of the system, a node may be a core in a multi-core processor on a board, it may be a computer system in a room of computer systems that work together, it may be a group of computer systems in the cloud, or it may be some other computing entity in a group of computing entities working together on a job.

The term ‘synchronization point’, as used in this document, refers to a point that multiple nodes, operating in parallel, are intended to reach at the same time. In some embodiments, this intent is so that the nodes may synchronize or combine the results of their processing thus far. There may be multiple synchronization points between the start and finish of a job.

The term ‘path’, as used in this document, refers to the combination of code execution and communications that a specific node is expected to perform in completing its portion of the job.

The term ‘critical path’, as used in this document, refers to the path followed by the node that is expected to take the longest time to reach completion, as compared to the paths of the other nodes in the system. In some embodiments, a critical path may be defined before any nodes begin processing, based on predictions of things such as, but not limited to, complexity of the portion of the job assigned to that node, expected software and/or communications times, etc. In other embodiments, there may be no practical way to define the critical path before processing begins.

The critical path assignment may be changed from one node to another after each synchronization point, if it is predicted that a different node is going to reach completion later than the others. In some embodiments, this reassignment may be based partly or entirely on which node was slowest to reach the current synchronization point. In some embodiments, the assignment of critical path to a particular node may occur between synchronization points, if it is determined that one node is making slower progress than expected, as compared to the other nodes.

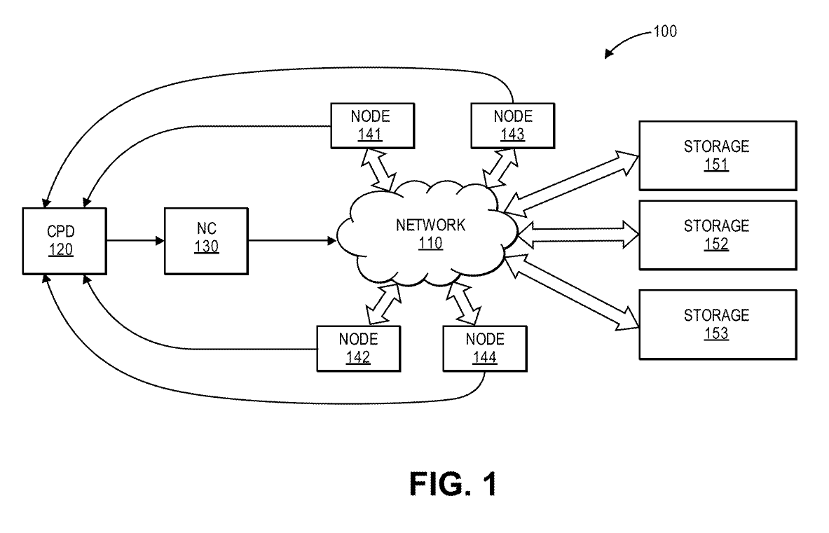

FIG. 1 shows a diagram of a multi-node processing system, according to an embodiment of the invention. In the illustrated embodiment, system 100 may contain a network 110 that permits nodes 141, 142, 143, and 144 to communicate bidirectionally with each other, and with storage units 151, 152, and 153. Four nodes and three storage units are shown in this example, but other quantities may also be used. Network controller (NC) 130 may exert control over communication between the various devices connected to the network. The multiple nodes may each take a task (a sub job of the overall job to be processed by the system) and process that task in parallel with the other nodes. In some embodiments, NC 130 may monitor and adjust the operation of the network, changing communication resources as needed to reduce the likelihood of idle time by the nodes.

Storage units 151, 152, and 153 may include data to be processed and data that has been processed, as well as data that is not involved in the current job. Although network 110 is shown as a single entity, it may be implemented in various forms. For example, it may be wired, wireless, or a combination of both. It may be implemented as a network in which all devices share a common bus or channel, or a network with multiple buses or channels. It may contain a communication control module internal to network 110 (not shown) to facilitate communications. Other implementations are also contemplated.

In some embodiments, the overall job may be divided into tasks that are approximately identical, so that each is expected to take about the same amount to time to complete. In other embodiments, the overall job may be divided into non-identical tasks. This may prompt a preliminary determination of a critical path, since the different nodes may be expected to have different completion times, even before processing ever starts.

Critical Path Detector (CPD) 120 may monitor the comparative progress of each node by comparing whether each node has reached the same synchronization point at the same time (plus or minus a permitted variance). For example, each node should reach its first synchronization point at the same time as the other nodes, reach its second synchronization point at the same time as the other nodes, etc. Dynamic monitoring of the comparative progress of each node even before they reach the synchronization point is another option on how CPD may be designed. Other options are possible as well, such as: prediction based on some other telemetry information from the system, based on previous job performance, or other techniques not specifically described here.

As a result of its operation, the CPD may determine that one node is falling behind the others. The ‘critical path’ designation may then be assigned to that node and its subsequent execution/communications. To prevent the critical path node from continuing to lag behind the others, a method may be determined for speeding up the subsequent communications for that node. In some cases, multiple nodes may reach the synchronization point later than the fastest node. In such a case, a method may be determined for speeding up each of the lagging nodes (typically at the cost of slowing down the fastest node), by amounts that are anticipated to cause every node to reach the next synchronization point at the same time.

The relative amount of speeding up, or slowing down, may be based on the relative differences between when each node reached the current synchronization point. In some embodiments, each of the relevant nodes may be given a different adjustment in its subsequent communications. This adjusting of communication speed may be achieved by changing the communication resources involved in the various links that will be used in subsequent communication sequence(s), though other techniques may be used instead or in addition to this method. These communication resources may be those used for communications between processors 141, 142, 143, 144, as well as storage units 151, 512, 153.

Various techniques may be used to adjust relative communication speeds. For example, the messages communicated by one node may be given higher priority than the others, thereby increasing the chances that those messages will complete sooner. Similarly, a communication channel being used by one node may be given higher priority than the other channels, similarly increasing the chances that communications on that channel will complete sooner.

Another technique is to change the relative bandwidth of each node's communication. For example, in a communications system in which a channel is made up of multiple sub-channels and each node is assigned to one or more of those sub-channels, the number of sub-channels assigned to each node may be changed, thereby increasing or decreasing the amount of data that can be communicated by a node in parallel with the other nodes. Other techniques of changing relative bandwidth may include changing the frequency used on a channel (higher frequencies may convey more bits/sec), and/or changing the modulation techniques used, so that more bits/cycle may be conveyed at the same base frequency. Other techniques not specifically described here may also be used.

It should be pointed out that the various embodiments of the invention use a change in communication resources to adjust how long it takes a particular node to reach the next synchronization point. A node may also adjust processing parameters (e.g., clock frequency, CPU voltage, etc.) to adjust how long it takes the node to perform its internal processing functions. However, changes in processing parameters are not considered to be part of the embodiments of this invention and are ignored in this document for the purpose of achieving results. However, a variance in processing parameters may affect how quickly a node reaches its next synchronization point in the current interval, and may therefore affect whether a communication adjustment will be needed in the next interval.

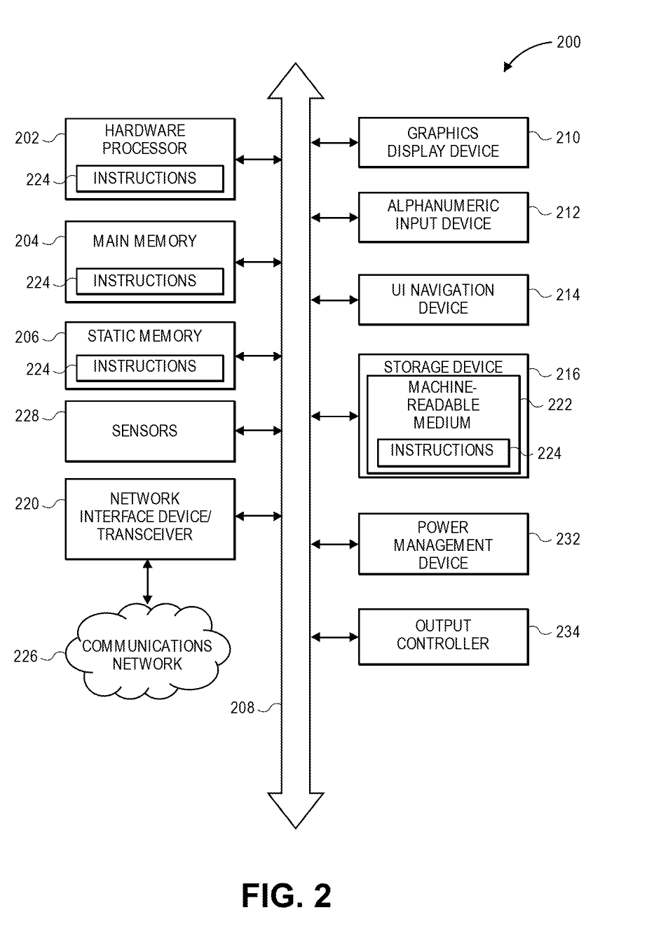

FIG. 2 shows a processing device, according to an embodiment of the invention. In some embodiments, device 200 may be an example of any of devices 141, 142, 143, 144, 151, 152, or 153 in FIG. 1. Device 200 may include modules such as, but not limited to, processor 202, memories 204 and 206, sensors 228, network interface 220, graphics display device 210, alphanumeric input device 212 (such as a keyboard), user interface navigation device 214, storage device 216 containing a machine readable medium 222, power management device 232, and output controller 234. Instructions 224 may be executed to perform the various functions described in this document. They are shown in multiple memories, though this is not a requirement. Communications network 226 may be a network external to the device, through which the device 200 may communicate with other devices. Any of nodes 141, 142, 143, 144, storage units 1151, 152, 153 in FIG. 1 may contain any or all of the components shown in FIG. 2.

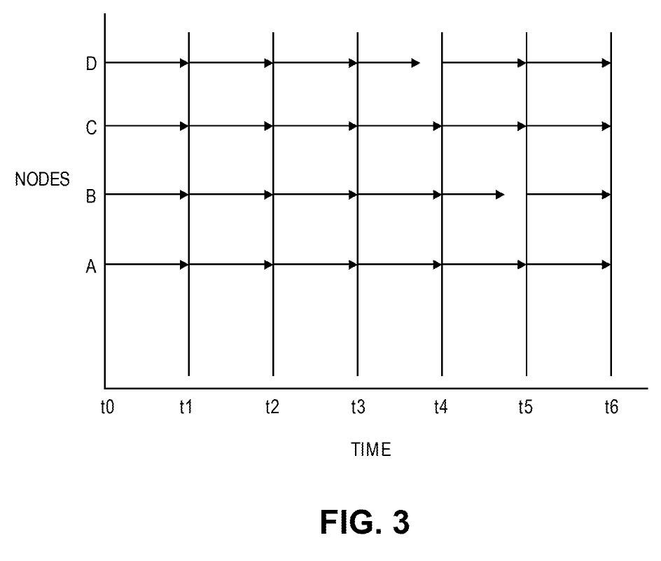

FIG. 3 shows a timing chart of a system of parallel processing nodes, according to an embodiment of the invention. In FIG. 3, nodes A, B, C, and D are shown on the vertical axis. The horizontal axis shows time, which has been divided into starting point t0, synchronization points t1, t2, t3, t4, t5, and completion point t6. In this example, each node is supposed to reach the same synchronization point at the same time, which they do for synchronization points t1, t2, and t3. However, between synchronization points t3 and t4, node D is shown to operate more slowly than the others, and nodes A, B, C have to wait for node D to reach t4 before all four nodes can synchronize at t4. This causes nodes A, B, C to waste energy and time while waiting idly for node D to catch up. It also delays reaching the completion point by all the nodes. Node D may therefore be assigned ‘critical path’ status. An adjustment may then be made to accelerate how quickly node D can proceed, as compared to nodes A, B, and C. Within the context of the embodiments of this invention, node D may communicate during that interval more quickly, nodes A-C may communicate more slowly, or both.

In this particular example, node B is now shown to reach t5 later than nodes A, C, D. Now nodes A, C, D have to sit idle waiting for node B to catch up. The ‘critical path’ status may therefore be assigned to node B. Again, an adjustment in communication resources may adjust how quickly each node can proceed from synchronization point t5 to completion point t6. In this example, the final adjustment is optimal and all four nodes reach completion point t6 at the same time. Strictly as an example, this embodiment shows five synchronization points between the starting point and the completion point, and four nodes. However, other embodiments may have other quantities of synchronization points and nodes.

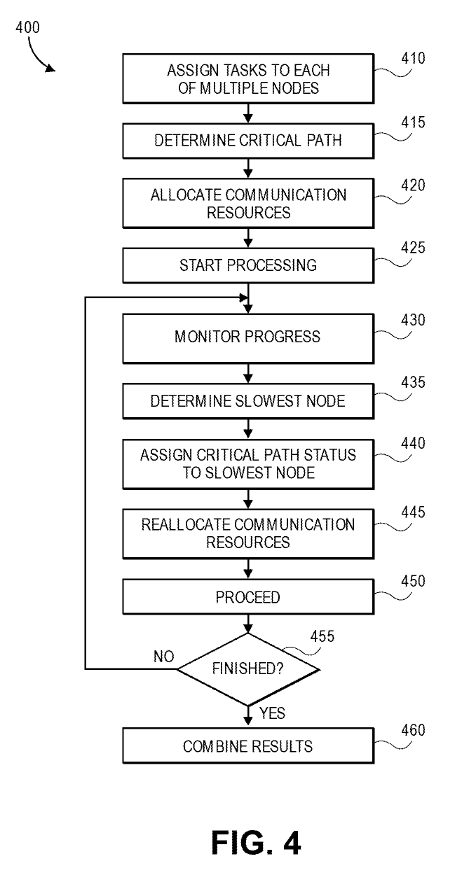

FIG. 4 shows a flow diagram of a method of execution along a critical path, according to an embodiment of the invention. In flow diagram 400, at 410 a job to be completed may be divided into tasks that can be processed in parallel, and each task may then be assigned to a separate node. In some embodiments, based on the particulars of each task and the capabilities of the assigned node, an estimation may be made of which node is likely to take longer to complete its task. The processing path to be followed by this node may then be designated as the critical path at 415. In other embodiments, no critical path may be designated at this initial stage.

At 420, various communication resources may be allocated for the network 110 that connects the various devices in system 100. These resources may be allocated with the expectation that this allocation will permit the various nodes to complete their task at the same time. If a critical path has been designated, these resources may impart a speed advantage to the node associated with the critical path.

At 425, the various nodes may begin processing their assigned tasks. At 430, the Critical Path Detector (CPD) may monitor the progress of each node. In some embodiments, this may be done by determining when each node reaches the first synchronization point. However, in other embodiments this may be done by monitoring relative progress between synchronization points. If one node is progressing slower than the other nodes to reach that point, as determined at 435, then the CPD may reassign Critical Path status to that node at 440. It may then direct the network controller to reallocate communication resources at 445 such that the slower node will have a communications advantage going forward.

All the nodes may then proceed at 450. If there are no more synchronization points before the nodes reach completion of their tasks, then processing may be finished at 455, and the results for the job combined at 460. If there are more synchronization points, flow may return to 430. As can be seen from this description, as well as the description of FIG. 3, there is a potential for the critical path designation to be reassigned at each synchronization point or at any other moment.

### EXAMPLES

The following examples pertain to particular embodiments:

Example 1 includes a device having logic configured to: monitor when first and second computer nodes reach a first synchronization point; determine if the first node reaches the first synchronization point later than the second node; and if the first node is determined to reach the first synchronization point later than the second node, direct a network controller to reallocate more network resources to the first node to attempt to have the first node reach a second synchronization point simultaneously with the second node.

Example 2 includes the device of example 1, wherein said reallocating more network resources comprises assigning higher priority to communications by the first node.

Example 3 includes the device of example 1, wherein said reallocating more network resources comprises changing bandwidth of communications by the first node.

Example 4 includes a method of controlling a multi-node processor system, comprising: monitoring when first and second nodes reach a first synchronization point; determining if the first node reaches the first synchronization point later than the second node; if the first node is determined to reach the first synchronization point later than the second node, directing a network controller to reallocate more network resources to the first node to attempt to have the first node reach a second synchronization point simultaneously with the second node.

Example 5 includes the method of example 4, wherein said reallocating more network resources comprises assigning higher priority to communications by the first node.

Example 6 includes the method of example 4, wherein said reallocating more network resources comprises changing bandwidth for communications by the first node.

Example 7 includes a computer-readable non-transitory storage medium that contains instructions, which when executed by one or more processors result in performing operations comprising: monitoring when first and second processing nodes reach a first synchronization point; determining if the first node reaches the first synchronization point later than the second node; if the first node is determined to reach the first synchronization point later than the second node, directing a network controller to reallocate more network resources to the first node to attempt to have the first node reach a second synchronization point simultaneously with the second node.

Example 8 includes the medium of example 7, wherein the operation of reallocating more network resources comprises assigning higher priority to communications by the first node.

Example 9 includes the medium of example 7, wherein the operation of reallocating more network resources comprises changing bandwidth in communications by the first node.

Example 10 includes a device having means to: monitor when first and second computer nodes reach a first synchronization point; determine if the first node reaches the first synchronization point later than the second node; if the first node is determined to reach the first synchronization point later than the second node, direct a network controller to reallocate more network resources to the first node to attempt to have the first node reach a second synchronization point simultaneously with the second node.

Example 11 includes the device of example 10, wherein said means to reallocate more network resources comprises means to assign higher priority to communications by the first node.

Example 12 includes the device of example 10, wherein said means to reallocate more network resources comprises means to change bandwidth of communications by the first node.

Example 13 includes a processing system comprising: multiple computer nodes; a network coupled to the multiple nodes; a network controller coupled to the network to control communications between the multiple nodes; and a critical path detector (CPD) coupled to each of the nodes; wherein the multiple nodes are each to process in parallel a separate part of a job; wherein the CPD is to determine that a first node arrives at a first synchronization point later than other nodes that are processing other parts of the job; wherein the network controller is to adjust network resources to accelerate communication by the first node to reach a second synchronization point at a same time as the other nodes.

Example 14 includes the system of example 13, wherein the network controller is to adjust network resources by adjusting priority of network messages between nodes.

Example 15 includes the system of example 13, wherein the network controller is to adjust network resources by adjusting bandwidth allocation between nodes.

Example 16 includes the system of example 13, wherein the system is to have multiple synchronization points.

Example 17 includes the system of example 13, further comprising one or more storage units coupled to the network.

Example 18 includes a method of controlling parallel processing in a system, comprising: processing in parallel, by each of multiple nodes, separate parts of a job; determining that first and second nodes of the multiple nodes do not reach a first synchronization point simultaneously; and if the first and second nodes do not reach the first synchronization point simultaneously, adjusting network resources such that the first and second nodes will reach a second synchronization point simultaneously.

Example 19 includes the method of example 18, wherein said adjusting network resources comprises adjusting priority of network messages between nodes.

Example 20 includes the method of example 18, wherein said adjusting network resources comprises adjusting bandwidth allocation between nodes.

Example 21 includes a computer-readable non-transitory storage medium that contains instructions, which when executed by one or more processors result in performing operations comprising: processing in parallel, by each of multiple nodes, separate parts of a job; determining that first and second nodes of the multiple nodes do not reach a first synchronization point simultaneously; and if the first and second nodes do not reach the first synchronization point simultaneously, adjusting network resources such that the first and second nodes will reach a second synchronization point simultaneously.

Example 22 includes the medium of example 21, wherein the operation of adjusting network resources comprises adjusting priority of network messages between nodes.

Example 23 includes the medium of claim 21, wherein the operation of adjusting network resources comprises adjusting bandwidth allocation between nodes.

The foregoing description is intended to be illustrative and not limiting. Variations will occur to those of skill in the art. Those variations are intended to be included in the various embodiments of the invention, which are limited only by the scope of the following claims.

What is claimed is:

1. A device having logic configured to:
monitor when first and second computer nodes reach a first synchronization point;
determine if the first node reaches the first synchronization point later than the second node;
if the first node is determined to reach the first synchronization point later than the second node, direct a network controller to reallocate more network resources to the first node to attempt to have the first node reach a second synchronization point simultaneously with the second node.

2. The device of claim 1, wherein said reallocating more network resources comprises assigning higher priority to communications by the first node.

3. The device of claim 1, wherein said reallocating more network resources comprises changing bandwidth of communications by the first node.

4. A method of controlling a multi-node processor system, comprising:
monitoring when first and second nodes reach a first synchronization point;
determining if the first node reaches the first synchronization point later than the second node;
if the first node is determined to reach the first synchronization point later than the second node, directing a network controller to reallocate more network resources to the first node to attempt to have the first node reach a second synchronization point simultaneously with the second node.

5. The method of claim 4, wherein said reallocating more network resources comprises assigning higher priority to communications by the first node.

6. The method of claim 4, wherein said reallocating more network resources comprises changing bandwidth for communications by the first node.

7. A computer-readable non-transitory storage medium that contains instructions, which when executed by one or more processors result in performing operations comprising:
monitoring when first and second processing nodes reach a first synchronization point;
determining if the first node reaches the first synchronization point later than the second node;
if the first node is determined to reach the first synchronization point later than the second node, directing a network controller to reallocate more network resources to the first node to attempt to have the first node reach a second synchronization point simultaneously with the second node.

8. The medium of claim 7, wherein the operation of reallocating more network resources comprises assigning higher priority to communications by the first node.

9. The medium of claim 7, wherein the operation of reallocating more network resources comprises changing bandwidth in communications by the first node.

10. A processing system comprising:
multiple computer nodes;
a network coupled to the multiple nodes;
a network controller coupled to the network to control communications between the multiple nodes; and
a critical path detector (CPD) coupled to each of the nodes;
wherein the multiple nodes are each to process in parallel a separate part of a job;
wherein the CPD is to determine that a first node arrives at a first synchronization point later than other nodes that are processing other parts of the job;
wherein the network controller is to adjust network resources to accelerate communication by the first node to reach a second synchronization point at a same time as the other nodes.

11. The system of claim 10, wherein the network controller is to adjust network resources by adjusting priority of network messages between nodes.

12. The system of claim 10, wherein the network controller is to adjust network resources by adjusting bandwidth allocation between nodes.

13. The system of claim 10, wherein the system is to have multiple synchronization points.

14. The system of claim 10, further comprising one or more storage units coupled to the network.

15. A computer-readable non-transitory storage medium that contains instructions, which when executed by one or more processors result in performing operations comprising:
processing in parallel, by each of multiple nodes, separate parts of a job;
determining that first and second nodes of the multiple nodes do not reach a first synchronization point simultaneously; and
if the first and second nodes do not reach the first synchronization point simultaneously, adjusting network resources such that the first and second nodes will reach a second synchronization point simultaneously.

16. The medium of claim 15, wherein the operation of adjusting network resources comprises adjusting priority of network messages between nodes.

17. The medium of claim 15, wherein the operation of adjusting network resources comprises adjusting bandwidth allocation between nodes.
